(19) United States
(12) Patent Application Publication
(10) Pub. No.: US 2012/0051919 A1
(43) Pub. Date: Mar. 1, 2012

(54) POWDER COMPACT ROTOR FORGING PREFORM AND FORGED POWDER COMPACT TURBINE ROTOR AND METHODS OF MAKING THE SAME

(75) Inventors: Raymond Joseph Stonitsch, Simpsonville, SC (US); George Albert Goller, Greenville, SC (US); Joseph Jay Jackson, Greer, SC (US); David Paul Mourer, Lynn, MA (US); Daniel Yeuching Wei, Reading, MA (US)

(73) Assignee: GENERAL ELECTRIC COMPANY, Schenectady, NY (US)

(21) Appl. No.: 12/872,671

(22) Filed: Aug. 31, 2010

(51) Int. Cl. F01D 5/02; B22F 3/15; B22F 3/24; B32B 15/00; B22F 3/12

(52) U.S. Cl. 416/204 A; 428/577; 419/1; 419/28; 419/23; 419/49

(57) ABSTRACT

A forging preform for a turbine rotor disk is disclosed. The preform includes a body of a superalloy material having a mass of about 5000 lbs or more, the superalloy material having a substantially homogeneous grain morphology and an ASTM average grain size of 10 or smaller. 5. A turbine rotor disk is also disclosed. The disk includes a substantially cylindrical disk of a superalloy material having a mass of about 5000 lbs or more, the superalloy material having a substantially homogeneous grain morphology and an ASTM average grain size of about 10 or smaller. A method of making a turbine rotor disk is also disclosed. The method includes providing a superalloy powder material and pressing the superalloy powder material to form a forging preform for a turbine rotor disk.

### BACKGROUND OF THE INVENTION

The subject matter disclosed herein relates to forged turbine rotors and methods of making the same, and more particularly, to forged powder compact turbine rotors and methods of making the same.

The rotor disk sections of the rotors used in industrial gas turbines are currently cast and wrought. In order to make these disks, large ingots of various superalloy materials are formed using various casting techniques, including vacuum induction melting (VIM), eletroslag remelting (ESR) or vacuum arc remelting (VAR). These ingots may be on the order of 30-36″ in diameter and weigh between 22,000-35,000 lbs. Control of the melting and casting process is critical, particularly control implemented to limit segregation within the cast ingot.

The cast ingots are wrought by upset forging and billetized to create a preform or billet for final forging of the rotor disk sections. The billetizing process generally involves multiple steps, including up to about 15 steps, to form the forging preform. The forging preform generally has a relatively coarse grain size of about ASTM 0-4. The billet is generally not readily inspectable by non destructive methods such as ultrasonic inspection. Also, the top and bottom of the billets are generally cropped resulting in undesirable scrap.

Final forging of the billets into wrought rotor sections requires a large forging press, with the press size generally determined by the size of the rotor section desired. As the size of industrial gas turbines increases to achieve higher power outputs and efficiencies, these forgings may require very large forging presses, including presses having a capacity of about 75,000 tons. Such large presses are generally very costly to manufacture and operate owing to their large sizes and the associated facilities and utilities needed to run them.

The number of forging steps is critical due to abnormal grain growth (AGG) that may occur during extended time at high temperature necessary to perform the forming operations, particularly where isothermal forging at low strain rates are employed. AGG during the forging process can result in variations within the microstructure, particularly abnormal variations in the average grain size across the diameter and through the thickness of forging. In addition, larger rotor sections require larger forging envelopes that necessitate removal of more material after forging, which in turn increases the cost of the forging.

Careful control of the casting and forging processes are capable of producing large cast and wrought rotor sections having an average ASTM grain size of about 8. The yield strength and elongation in the bore region of the rotor section forgings are generally limited by the relatively slower cooling that occurs in this region due to their size and associated thermal mass. Cast and wrought rotor sections also generally have a non-uniform distribution of carbides across the diameter and through the thickness of the forging, with higher amounts of carbides in the central or bore region due to the fact that this is the slowest cooling portion of the ingots from which they are formed. The forgings are forged with the central portions being solid and the bores are formed afterwards by removing material from the central portion of the forgings.

Therefore, it is desirable to provide turbine rotors and associated turbine disks having improved mechanical and metallurgical properties, as well as improved methods of making them.

### BRIEF DESCRIPTION OF THE INVENTION

According to one aspect of the invention, a forging preform for a turbine rotor disk is disclosed. The preform includes a body of a superalloy material having a mass of about 5000 lbs or more, the superalloy material having a substantially homogeneous grain morphology and an ASTM average grain size of 10 or smaller.

According to another aspect of the invention, a turbine rotor disk is disclosed. The turbine rotor disk includes a substantially cylindrical disk of a superalloy material having a mass of about 5000 lbs or more, the superalloy material having a substantially homogeneous grain morphology and an ASTM average grain size of about 10 or smaller.

According to yet another aspect of the invention, a method of making a turbine rotor disk is disclosed. The method includes providing a superalloy powder material. The method also includes pressing the superalloy powder material to form a forging preform for a turbine rotor disk, the preform comprising a body of a superalloy material having a mass of about 5000 lbs or more, the superalloy material having a substantially homogeneous grain morphology and an ASTM average grain size of 10 or smaller.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front partial cross-sectional perspective view of an exemplary embodiment of turbine and a plurality of turbine wheels as disclosed herein;

FIGS. 2A-2C are schematic illustrations of exemplary embodiments of a method of making a turbine wheel and a turbine wheel made thereby as disclosed herein; and

FIG. 3 is a flow diagram of an exemplary embodiment of a method of making a turbine wheel as disclosed herein.

The detailed description explains embodiments of the invention, together with advantages and features, by way of example with reference to the drawings.

### DETAILED DESCRIPTION OF THE INVENTION

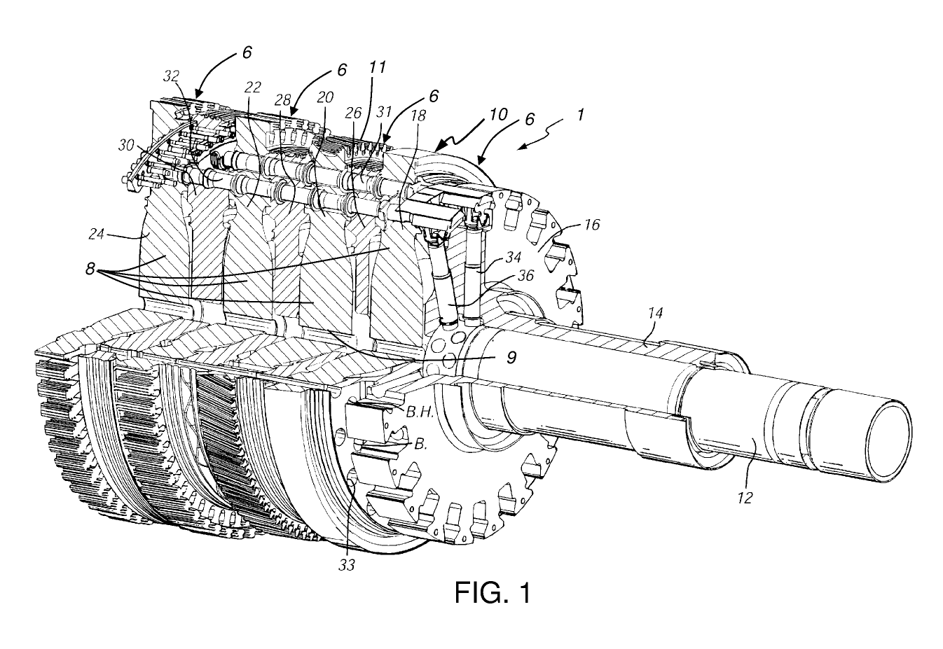

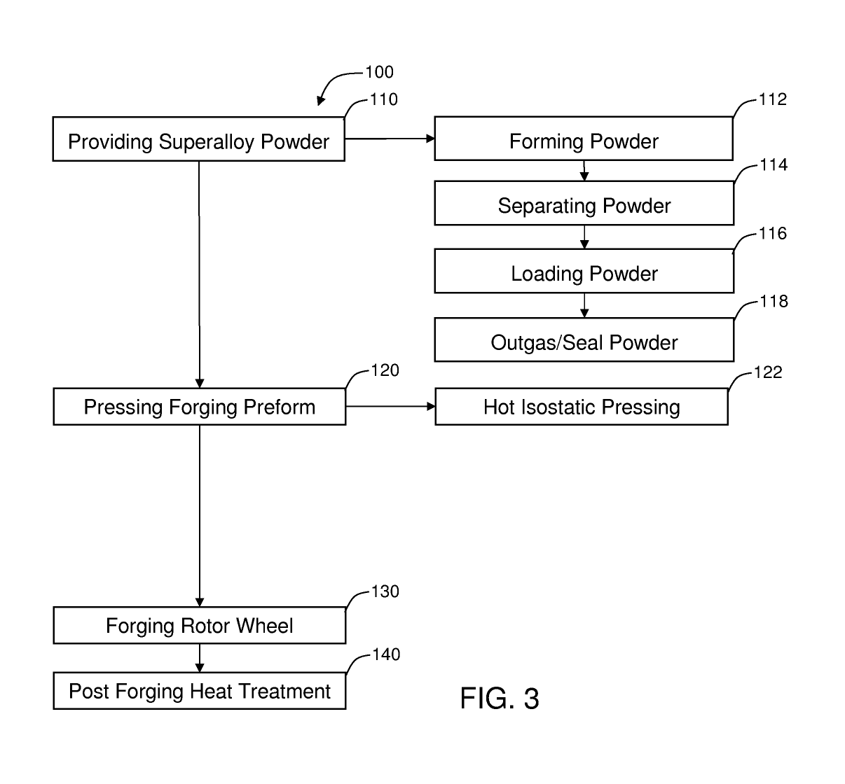

Referring to the FIGS. 1-3, a forged turbine rotor wheel 6 is disclosed for use in the turbine rotor 10 of an industrial gas turbine 1.

Referring to FIG. 1, there is illustrated a portion of a gas turbine rotor, generally designated 10. Rotor 10 includes an aft bore tube assembly 12, an aft shaft 14 having a forward aft shaft disk 16 and a plurality of disks or wheels 6, including rotor wheels 18, 20, 22 and 24 axially spaced one from the other by a plurality of spacers 7, including spacers 26, 28 and 30. In the illustrated exemplary embodiment, rotor 10 comprises four stages, each including a wheel 6 and a spacer 7, the first stage being only partially shown. The outer rims of the wheels are configured to mount turbine buckets, not shown, while the outer rims of the spacers lie in radial opposition to associated nozzles, also not shown. In the exemplary embodiment illustrated, the advanced gas turbine design, part of which is illustrated in FIG. 1, comprises a steam-cooled, four-stage turbine having steam supply and return tubes 31 and 32, respectively. Tubes 31 and 32 are circumferentially spaced about and extend axially of the rotor 10 and lie in communication with radial steam supply and return tubes 34 and 36, respectively. Steam may be supplied through the bore tube assembly 12 to the radial tubes 34 and returning spent cooling steam is supplied to the bore tube assembly 12 from radial tubes 36. The stack of wheels, spacers and aft shaft disk are bolted one to the other as in conventional rotor construction, a bolt B being illustrated. Thus, the bolt holes (B.H.) pass axially through each of the wheels and spacers and lie in axial registry with one another at circumferentially spaced-apart positions at locations radially inwardly of the steam tubes 31 and 32 that are inserted into the rotor after assembly and which require close tolerance fit-ups with the openings 33 through the wheels, spacers and aft shaft disk.

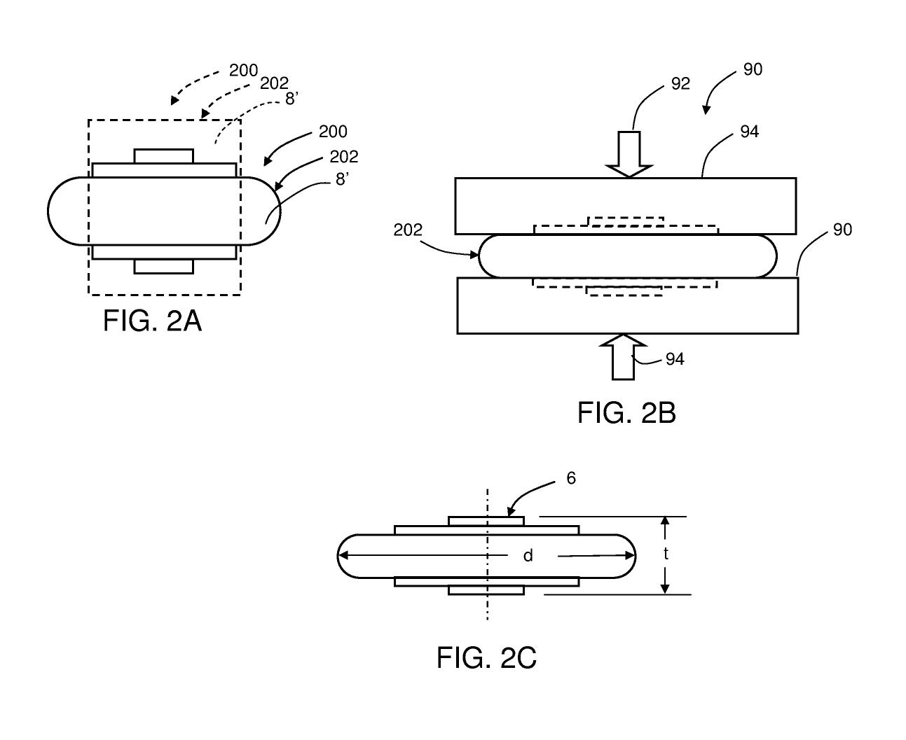

Referring to FIGS. 1 and 2, rotor disks or wheels 6 each include a forged powder compact that may be forged using conventional forging methods, as described herein. Rotor wheels 6 each include a substantially cylindrical disk of a superalloy material 8. The wheel may be of any suitable size and configuration, such as the configurations of wheels 18, 20, 22 and 24. Rotor wheels 6 for use in large industrial gas turbines having a mass of about 5,000 lbs or more, and more particularly may have a mass of about 16,000 lbs or more, and even more particularly may have a mass that is between about 5,000 lbs to about 16,000 lbs.

The rotor wheels 6 may be formed from a high-temperature superalloy material 8. Any suitable high temperature alloy may be used, including various Fe-base, Fe—Ni-base, Ni-base or Co-base superalloys, and more particularly including Alloy 625 (UNS N06625), Alloy 706 (UNS N09706), Alloy 718 (UNS N07718) or Alloy 725 (UNS N07725) and derivatives of these alloys. The rotor wheels 6 have a substantially homogeneous as-forged microstructure and grain morphology, including a substantially-uniform, monomodal, equiaxed, as-forged microstructure and grain morphology, and exhibit an absence of abnormal grain growth (AGG). More particularly, the as-forged rotors have an ASTM E112 or E1382 average grain size of about 10 or smaller, and even more particularly an ASTM grain size of about 10 to about 16. The turbine rotor wheels or disks 6 comprise as-forged, powder compacts having densities that are about 99.9% of the theoretical density. It will be appreciated that the rotor wheels 6, including, for example, wheels 18, 20, 22 and 24 may each be formed from the same superalloy material or may each be formed from different superalloy materials, in any combination.

The turbine rotor wheels 6 disclosed herein have improved microstructural homogeneity that also provides improved homogeneity in the mechanical properties, including, for example, improved uniformity of the elongation, yield strength and ultimate tensile strength of the superalloy materials 8 both across the diameter d and through the thickness t, FIG. 2C. Thus, the rotor wheels 6 may have an elongation, yield strength and ultimate tensile strength of the superalloy materials 8 that is anisotropic and substantially the same throughout the rotor wheel 6, both across the diameter d and through the thickness t, as well as in other directions within rotor wheel 6. For example, in one exemplary embodiment, the rotor wheel 6 has a central bore 9 and an outer edge 11, the superalloy material has an elongation, yield strength and ultimate tensile strength, and these properties are substantially the same from the central bore 9 to the outer edge 11. In one particular embodiment, the rotor wheel 6 is formed from Alloy 706, and the elongation was at least about 17%, the yield strength was at least about 142 ksi and the ultimate tensile strength was at least about 180 ksi. In another embodiment, the elongation, yield strength and ultimate tensile strength of a powder compact forged rotor disk of a superalloy material as described herein was improved over the elongation, yield strength and ultimate tensile strength of a similarly configured cast and wrought rotor of the same superalloy material by about 10% to about 100%. Referring to FIGS. 2A-C and 3, the turbine rotor wheels 6 may be formed by a method 100 that includes: providing 110 a superalloy powder material, not shown; and pressing 120 the superalloy powder material to form a sintered powder compact forging preform 200, FIG. 2A. The method 100 may also include forging 130 the forging preform 200, FIG. 2B, to form a turbine rotor wheel 6, FIG. 2C.

Providing 110 the superalloy powder material may include forming 112 a plurality of powder particles of an Fe-base, Fe—Ni base, Ni-base or Co-base superalloy having a powder particle size of about −150 mesh using vacuum melting. The vacuum melting method used for forming 112 may include using ESR, VAR or VIM to melt the superalloy material. The molten superalloy material may then be atomized to form molten droplets that upon freezing comprise the superalloy powder particles. The atomization may be performed in an inert gas atmosphere, such as an argon atmosphere. VIM is well-suited for providing 110 the quantities of superalloy powder material needed for method 100. For example, VIM may be used to batch produce batches of powder of about 5,000 lbs to about 8,000 lbs or larger. The superalloy powder particles have a substantially homogeneous microstructure, and particularly exhibit substantially no segregation of the alloy constituents. Following forming 112, providing 110 may also include separating 114 the powder particles to provide a predetermined powder particle size, such as a size of about −150 mesh. Separating 114 may include any suitable method of separating the powder particles by size, including the use of various combinations of sieves. Providing 110 may also include loading 116 the powder particles into a container or can, not shown, in preparation for pressing 120. The can may comprise any suitable material, and may include various metals, including various grades of steel, and further including various grades of stainless steel. Following loading 116 the powder particles into a container or can, providing 110 may also include outgassing and sealing 118 the container to remove moisture or other volatile contaminants that are adsorbed or otherwise associated with the powder particles. Outgassing 118 may be performed by heating the powder particles and container to vaporize the moisture or other volatile constituents. The heating temperature and time may be selected to assure removal of the volatile contaminants. Once the can and powder have been outgassed to achieve predetermined levels of the contaminants and evacuated, the containers are sealed, such as by welding, to maintain the desired conditions, including contaminant levels and partial pressure within the container. It is desirable to perform providing 110 to include all handling of the powder, including forming 112, separating 114, loading 116 and outgassing/sealing 118, in a desiccated, inert gas atmosphere, such as argon, or under vacuum conditions.

The sealed container containing the powder particles of the superalloy material may then be subjected to pressing 120 to form a sintered powder compact forging preform 200. The amount of superalloy material powder provided will be sufficient to produce the desired size of the forging preform 200. In an exemplary embodiment, the powder and resultant forging preform 200 may have a mass greater than about 5,000 lbs, and in another embodiment, a mass up to about 16,000 lbs., and more particularly, a mass greater than about 5,000 lbs up to about 16,000 lbs. Pressing 120 may include any suitable pressing method to sinter and consolidate the powder particles and form the forging preform 200. In an exemplary embodiment, pressing 120 may include hot isostatic pressing 122 at a temperature, pressure and time sufficient to form forging preform 200. Advantageously, the powder compact forging preform 200 may have any suitable shape, including that of a conventional substantially cylindrical forging billet 200 as shown in phantom in FIG. 2A, or including a near net shape wheel preform as also shown in FIG. 2A. In an exemplary embodiment, the forging preform 200 includes a body 202 of a superalloy material 8′ having a mass of about 5000 lbs or more, the superalloy material having a substantially homogeneous grain morphology and an ASTM average grain size of 10 or smaller. The forging preforms 200 have a substantially homogeneous as-pressed microstructure and grain morphology, including a substantially-uniform, monomodal, equiaxed, as-pressed grain morphology, and exhibit an absence of abnormal grain growth (AGG), such that the preforms are substantially free of AGG. The forging preforms 200 are also free of carbide segregation across their diameter through their thickness.

The method 100 also includes forging 130 the forging preform 200, FIG. 2B, to form a turbine rotor wheel 6, FIG. 2C. The forging preform 200 may have a mass of between about 5000 lbs to about 16,000 lbs or greater. Forging 130 may be performed using a forging press 90 and forging dies 94 having a maximum forging load 92 capacity that is smaller than those used for conventional forging of cast billets to form an equivalently sized rotor wheel 6, as described herein, of between about 35 to about 50 kilotons. Forging 130 of the powder compact forging preform 200 may be performed using conventional high strain rate forging methods by controlling the strain rate during forging, including during each forging step where multiple forging steps are employed. This is very advantageous compared to the forging of cast superalloys that generally require the use of slow strain rate isothermal forging methods. Conventional cast high-temperature alloys used to manufacture rotor wheels, including NiCrMoV-type low alloy steels and various superalloys, including Ni-base and Fe—Ni-base superalloys, were developed for superior elevated temperature strength and creep resistance. Cast ingots of these alloys are very difficult to process by conventional high strain rate forging methods. The superalloys described herein, which generally have higher amounts of alloying constituents and the highest elevated temperature strength and creep resistance, are even more temperature and strain rate sensitive, and thus are even more difficult to process using conventional high strain rate forging methods (e.g., 0.01/sec or faster). Thus, forging of cast ingots typically requires the use of low strain rate, superplastic, isothermal forging conditions to avoid the development of abnormal grain structure, including AGG, during post-forging heat treatments. The strain rates used for isothermal forging are low in order to reduce adiabatic heating of and to maintain superplastic material behavior within the forging. The strain rates used may include rates of less than about 0.01/sec to about 0.001/sec. Although the strain rates are lower and the forging times are longer during isothermal forging, there is no die chilling as in conventional forging, due to the fact that the forging dies are heated to the same temperature as the forging preform.

The forging temperatures of the forging preforms 200 during forging 130 may include subsolvus forging temperatures for the superalloy material 8 selected. Forging 130 may be performed in a single forging step, or in multiple forging steps.

Method 100 may also include a post-forging heat treatment 140, or multiple heat treatments, to develop the microstructure and mechanical properties of rotor wheels 6, including various combinations of solution heat treatments, stabilizing heat treatments and precipitation hardening heat treatments. Forging 130 of powder compact forging preforms avoids the development of retained strain within the microstructure of the superalloy material 8 and the problem of AGG both during forging 130 and during post-forging heat treatment 140, such that the resultant as-forged microstructure of disks or wheels 6 is substantially free of AGG. The as-forged microstructure is also free of carbide segregation across the diameter (e.g., about 17 to about 40 inches) and through the thickness of the as-forged disk.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A forging preform for a turbine rotor disk, comprising:
a body of a superalloy material having a mass of about 5000 lbs or more, the superalloy material having a substantially homogeneous grain morphology and an ASTM average grain size of 10 or smaller.

2. The turbine rotor disk preform of claim 1, wherein the superalloy material comprises an Fe-base, Fe—Ni-base, Ni-base or Co-base superalloy.

3. The turbine rotor disk preform of claim 1, wherein the body comprises a powder compact.

4. The turbine rotor disk preform of claim 1, wherein the mass is about 5000 to about 16,000 lbs.

5. A forged turbine rotor disk, comprising:
a substantially cylindrical disk of a superalloy material having a mass of about 5000 lbs or more, the superalloy material having a substantially homogeneous grain morphology and an ASTM average grain size of about 10 or smaller.

6. The turbine rotor disk of claim 5, wherein the superalloy material comprises an Fe-base, Fe—Ni-base, Ni-base or Co-base superalloy.

7. The turbine rotor disk of claim 5, wherein the disk comprises a powder compact.

8. The turbine rotor disk of claim 5, wherein the ASTM average grain size is about 10 to about 16.

9. The turbine rotor disk of claim 5, wherein the disk has a central bore and an outer edge, the sup eralloy material has an elongation and a yield strength, and the elongation and yield strength are substantially the same from the central bore to the outer edge.

10. The turbine rotor disk of claim 9, wherein the elongation is at least about 17% and the yield strength is at least about 142 ksi.

11. The turbine rotor disk of claim 9, wherein the superalloy material has ultimate tensile strength of at least about 180 ksi.

12. A method of making a turbine rotor, comprising:
providing a superalloy powder material; and
pressing the superalloy powder material to form a sintered powder compact forging preform for a turbine rotor disk.

13. The method of making a turbine rotor of claim 12, further comprising forging the forging preform to form a turbine rotor disk.

14. The method of making a turbine rotor of claim 12, wherein providing a superalloy powder material comprises forming a powder of an Fe-base, Fe—Ni base, Ni-base or Co-base superalloy having a powder particle size of about −150 mesh using a vacuum forming method.

15. The method of making a turbine rotor of claim 12, further comprising handling the superalloy powder material prior to pressing in a desiccated, inert gas atmosphere or a vacuum.

16. The method making a turbine rotor of claim 12, wherein pressing comprises hot isostatic pressing of the forging preform.

17. The method making a turbine rotor of claim 13, wherein the forging preform comprises a body of a superalloy material having a mass of about 5000 lbs or more, the superalloy material having a substantially homogeneous grain morphology and an ASTM average grain size of about 10 or smaller.

18. The method making a turbine rotor of claim 13, wherein the forging comprises forging at a subsolvus temperature and a controlled strain rate.

19. The method making a turbine rotor of claim 18, wherein the forging is performed in multiple steps.

20. The method making a turbine rotor of claim 13, wherein the forging forms a turbine rotor disk comprises a microstructure having a substantially homogeneous grain morphology and an ASTM average grain size of about 10 or smaller that is substantially free of abnormal grain growth and free of carbide segregation.
